(19) United States
(12) Patent Application Publication
(10) Pub. No.: US 2025/0358898 A1
(43) Pub. Date: Nov. 20, 2025

(54) METHOD AND SYSTEM FOR SHARING USER EQUIPMENT SESSION JOIN NOTIFICATION IN SERVICE ENABLER ARCHITECTURE LAYER NETWORK RESOURCE MANAGEMENT

(71) Applicant: Samsung Electronics Co., Ltd., Gyeonggi-do (KR)

(72) Inventor: Vijay Sangameshwara, Bangalore (IN)

(21) Appl. No.: 19/210,300

(22) Filed: May 16, 2025

(30) Foreign Application Priority Data
May 16, 2024 (IN) 202441038505
Apr. 17, 2025 (IN) 202441038505

(51) Int. Cl. H04W 76/40; H04L 67/02; H04W 28/02; H04W 76/20

(52) U.S. Cl. CPC H04W 76/40; H04L 67/02; H04W 28/0268; H04W 76/20

(57) ABSTRACT

The disclosure relates to a 5G or 6G communication system for supporting a higher data transmission rate. Disclosed is a method and system for sharing a user equipment (UE) session join notification for a multicast and broadcast services (MBS) session in 5th generation (5G) using service enabler architecture layer (SEAL) network resource management (SNRM) service. The method includes generating, by the UE, a hypertext transfer protocol (HTTP) POST request based on a request from a vertical application layer (VAL) client of the UE, and transmitting, by the UE, the UE session join notification for the MBS session using the HTTP POST request to a SEAL network resource management-server (SNRM-S).

### CROSS REFERENCE TO RELATED APPLICATIONS

This application is based on and claims priority under 35 U.S.C. § 119 (a) to Indian Provisional Patent Application No. 202441038505, which was filed in the Indian Intellectual Property Office on May 16, 2024, and to Indian Complete Patent Application Serial No. 202441038505, which was filed in the Indian Intellectual Property Office on Apr. 17, 2025, the entire disclosure of each of which is incorporated herein by reference.

### BACKGROUND

### 1. Field

The disclosure relates generally to service enabler architecture layer (SEAL) network resource management, and more particularly, to a method and system for sharing user equipment (UE) session join notification in the SEAL network resource management service.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as an LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

SEAL is a standard for fifth generation (5G) network vertical applications, and services offered by enable layer. This SEAL standard sets forth how the operators can leverage the SEAL to quickly develop and deploy the vertical applications over the 5G network. The SEAL network resource management offers the network resource management (e.g., unicast, multicast, and broadcast network resources) and monitoring related capabilities to one or more vertical applications.

The relevant 3^{rd} generation partnership project (3GPP) technical specifications (TSs) for the network resource management (NRM) do not define any procedure for the SEAL network resource management client (SNRM-C) to share UE session join notifications when the vertical application layer (VAL) user joins a group associated with a multicast and broadcast services (MBS) session that is created over the 5G network for a group communication service by the SEAL network resource management server (SNRM-S). The join notification is crucial for the SNRM-S to inform the VAL group server about the VAL user readiness to send or receive the group media, such as an audio, video, or text file, over this MBS session through multicast or broadcast in the 5G network during the active group communication.

Thus, there is a need in the art for a method and apparatus for sharing the UE session join notification to the VAL group server when the VAL user joins the VAL group hosted over the 5G network.

### SUMMARY

The disclosure has been made to address at least the above-mentioned problems and/or disadvantages and to provide at least the advantages described below.

Accordingly, an aspect of the disclosure is to provide a high-level procedure for sharing the UE session join notification using HTTP protocol.

An aspect of the disclosure is to enable the SNRM-C to share the user MBS session join notification to SNRM-S.

An aspect of the disclosure is to provide techniques to efficiently enable the SNRM-C to share the user MBS session join notification to an SNRM-S when the VAL user joins a group associated with the MBS session used for group communication hosted over the 5G network.

In accordance with an aspect of the disclosure, a method for sharing a UE session join notification for an MBS session in 5G using an SNRM service includes generating, by the UE, a hypertext transfer protocol (HTTP) POST request based on a request from a VAL client of the UE and transmitting, by the UE, the UE session join notification for the MBS session using the HTTP POST request to an SNRM-S.

In accordance with an aspect of the disclosure, a system for sharing a UE session join notification for an MBS session in 5G using an SNRM service includes a memory and one or more processors coupled to the memory. The one or more processors are configured to generate an HTTP POST request based on a request from a VAL client of the UE and transmit, the UE session join notification for MBS session using the HTTP POST request towards an SNRM-S.

In accordance with an aspect of the disclosure, a method is provided in a 5G network, in which a user may join the VAL group which is served by the MBS session. Accordingly, the UE may generate an HTTP POST request message and transmit the HTTP POST request to the SNRM-S. The SNRM-S may process the HTTP POST request and may provide the response to the SNRM-C. In response, the UE may process the response from the SNRM-S for the UE session join notification and share to the VAL Client.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates an architecture for a SEAL over a 3GPP network system to support vertical applications, according to an embodiment;

FIG. 2 illustrates a signal flow for sharing a UE session join notification for an MBS session in 5G using an SNRM service, according to an embodiment;

FIG. 3 illustrates a system for sharing a UE session join notification for an MBS session in 5G using an SNRM service, according to an embodiment;

FIG. 4 illustrates a method for sharing a UE session join notification for an MBS session in 5G using an SNRM service, according to an embodiment; and

FIG. 5 illustrates a method for parsing a UE session join notification for an MBS session in 5G using an SNRM service, according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components. It will be understood by those within the art that, in general, terms used herein, and are generally intended as “open” terms (e.g., the term “including” may be interpreted as “including but not limited to,” the term “having” may be interpreted as “having at least,” the term “includes” may be interpreted as “includes but is not limited to,” etc.). For example, as an aid to understanding, the detail description may contain usage of the introductory phrases “at least one” and “one or more” to introduce recitations. However, the use of such phrases may not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” may typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation may typically be interpreted to mean at least the recited number (e.g., the bare recitation of “two recitations,” without other modifiers, typically means at least two recitations or two or more recitations).

Herein, the terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The present disclosure shows a Multicast and Broadcast Services (MBS) session where join notification is shared from SEAL Network Resource Management Client (SNRM-C) to SEAL Network Resource Management Server (SNRM-S), in accordance with some embodiments of the present disclosure.

Disclosed herein is an MBS session where join notification is shared from SNRM-C to SNRM-S, according to an embodiment.

The UE may include VAL client(s) and the SNRM-C. The VAL client and the SNRM-C associated with the UE may communicate with the SNRM-S through a communication network.

The VAL user may join the VAL group, which is hosted over the 5G network and served by the MBS session and may share VAL group in a join notification status. During the MBS session the SNRM-C associated with the UE may generate an HTTP POST request message and transmit the HTTP POST request to SNRM-S. In other words, the SNRM-C may transmit an MBS session(s) join notification to SNRM-S using an HTTP POST carrying MBS usage information in extensible markup language (XML). The HTTP POST is a method for sending data securely in the HTTP POST request body to a server to create/update a resource.

After receiving the HTTP request, the SNRM-S parses the request and may determine the action required by the SNRM-C and what data is required to fulfil the request. Accordingly, the SNRM-S may respond to the HTTP POST message request received from the SNRM-C. For instance, the SNRM-S may respond to the HTTP POST message request as a status information about the request or provide the requested data by the SNRM-C. In other words, the response to the request is transmitted to the SNRM-C.

After receiving the response from the SNRM-S, the SNRM-C may process the response and share the result of UE session join notification to VAL client(s). This UE session is shared whenever the VAL user joins a group associated with the MBS session used for group communication (for example, exchanging audio, video, text, files etc.) over the hosted 5G network.

The following is an MBS UE session join notification procedure according to an embodiment.

SNRM server HTTP procedure:

Upon receiving an HTTP POST request containing
an Content-Type header field with “application/vnd.3gpp.seal-mbs-usage-info+xml” value;

the SNRM-S:
a) shall determine the identity of the sender of the received HTTP POST request as specified in the relevant standard, and:
   1) if the identity of the sender of the received HTTP POST request is not authorized, shall respond with an HTTP 403 (Forbidden) response to the HTTP POST request and skip rest of the steps;
b) shall process the HTTP POST body carrying the UE session join notification status where the VAL identities, MBS session identity, MBS multicast joining status and mbs-reception-quality-level shared by the SNRM-C shall be processed by the SNRM-S and may store for future usage to serve requests from SNRM-C or VAL server associated with this information;
c) shall send the HTTP response towards the SNRM-C according to the relevant standard.

SNRM client HTTP procedure:

Upon request from VAL client to share the UE group join notification status with the SNRM-S, the SNRM-C shall generate an HTTP POST request in accordance with the relevant standard. In the HTTP POST request, the SNRM-C:
a) shall set the Request-URI to the URI corresponding to the identity of the SNRM-S;
b) shall include a Content-Type header field set to “application/vnd.3gpp.seal-mbs-usage-info+xml”;
c) shall include the mbs-usage-info XML payload encoded as per the XML schema specified in Table-1 in the HTTP POST body carrying the UE session join notification status generated as described below. The SNRM-C shall include <mbs-session-join-notification> under the <seal-mbs-usage-info> root element for the MBS session(s) it desires to share the group joining notification and each <mbs-session-join-notification> element;
   1) shall include the <VAL-identities> sub-element, shall include the following elements:
      A) a <VAL-user-id> element that contains the identity of the VAL user sharing the group join notification; and
      B) a <VAL-group-id> element set to the identity of the VAL group for whom the VAL user as joined; and
   2) shall include the <mbs-session-id> sub-element, set to the MBS session identifier indicating the MBS session associated with the group for which the group join notification is shared;
   3) shall include the <mbs-multicast-joining-status> sub-element, set to the string “successfully joined”;
   4)<mbs-reception-quality-level>, an optional element contains an integer used to indicate the reception quality level; and
d) shall send the HTTP POST request towards the SNRM-S according to the relevant standard.

Table 1 below illustrates an MBS usage XML schema extended with a user session join notification, according to an embodiment.

```
TABLE 1
XML schema for application/vnd.3gpp.seal-mbs-usage-info+xml
<?xml version=“1.0” encoding=“UTF-8”?>
<xs:schema xmlns:xs=“http://www.w3.org/2001/XMLSchema”
targetNamespace=“urn:3gpp:ns:sealMbsInfo:1.0”
xmlns:sealmbs=“urn:3gpp:ns:sealMbsInfo:1.0”
xmlns:sealinfo=“urn:3gpp:ns:sealInfo:1.0”
xmlns:sealmbms=“urn:3gpp:ns:sealMbmsInfo:1.0”
elementFormDefault=“qualified”
attributeFormDefault=“unqualified”
xmlns:xenc=“http://www.w3.org/2001/04/xmlenc#”>
  <!-- the root element -->
  <xs:element name=“seal-mbs-usage-info” type=“sealmbs:seal-mbs-usage-info-
Type” id=“mbs”/>
  <xs:complexType name=“seal-mbs-usage-info-Type”>
  <xs:sequence>
  <xs:element name=“mbs-session-join-notification” type=“mbs-session-join-
notificationType”
  minOccurs=“0”/>
  <xs:element name=“mbs-announcement” type=“sealmbs:mbs-
announcementTypeParams” minOccurs=“0”/>
  <xs:element name=“version” type=“xs:integer”/>
  <xs:any namespace=“##other” processContents=“lax” minOccurs=“0”
maxOccurs=“unbounded”/>
  </xs:sequence>
  <xs:anyAttribute namespace=“##any” processContents=“lax”/>
  </xs:complexType>
  <!--MBS Session Join Notification-->
  <xs:complexType name=“mbs-session-join-notificationType”>
  <xs:sequence>
  <xs:element name=“VAL-identities” type=“sealinfo:sealinfo-Type”
minOccurs=“1”/>
  <xs:element name=“mbs-session-id” type=“xs:string” minOccurs=“1”/>
  <xs:element name=“mbs-multicast-joining-status” type=“xs:string”
minOccurs=“1”/>
  <xs:element name=“mbs-reception-quality-level” type=“xs:integer”
minOccurs=“1”/>
  <xs:any namespace=“##other” processContents=“lax” minOccurs=“0”
maxOccurs=“unbounded”/>
  </xs:sequence>
  <xs:anyAttribute namespace=“##any” processContents=“lax”/>
  </xs:complexType>
  <!--MBS Session Join Notification-->
</xs:schema>
```

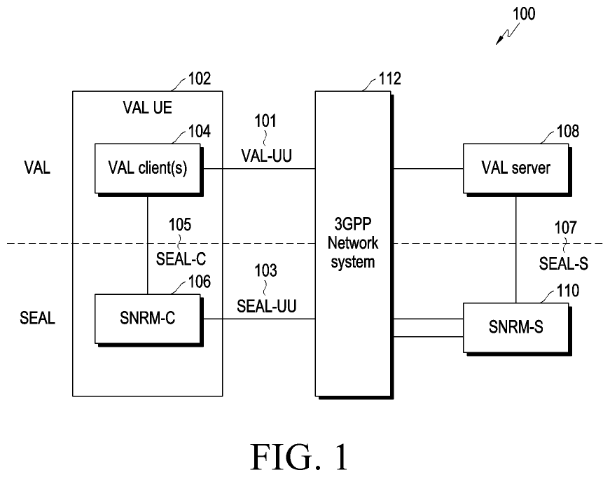

FIG. 1 illustrates an architecture for service enabler architecture layer (SEAL) network resource management (NRM) service over a 3GPP network system 112 to support vertical applications, according to an embodiment.

Referring to FIG. 1, the architecture 100 comprises a vertical application layer user equipment (VAL UE) 102 that may be used by a VAL user to participate in one or more VAL services. Further, VAL UE 102 comprises VAL client(s) 104 and a SEAL Network Resource Management Client (SNRM-C) 106. The architecture 100 further comprises a vertical application layer (VAL) server 108, a SEAL Network Resource Management Server (SNRM-S) 110, and a 3GPP network system 112.

The VAL UE 102 refers to the device(s) used by end-users to access the 3GPP network system 112 and its services. These devices, such as smartphones, Internet of things (IoT) gadgets, or other wireless-enabled endpoints, act as the entry point for communication with the network. Herein, the VAL UE 102 represents the VAL user device that joins a group communication session over the SEAL architecture. The VAL UE 102 initiates session join notifications and exchanges data during active group communication services. However, the VAL UE 102 is not limited to the above examples and any other device having 5G communication capability or higher may be within the scope of disclosure.

The VAL client(s) 104 on the VAL UE 102, provides the client-side functionalities corresponding to the vertical applications. The VAL client(s) 104 communicates with a VAL server 108 over a VAL-UU reference point 101, where UU represents the air interface between the UE and 3GPP network system 112. FIG. 1 shows the SEAL functional entities on the VAL UE 102, and the SNRM-C 106 and SNRM-S 110, to provide the network resource management related capabilities (e.g., broadcast and multicast network resources) to one or more vertical applications.

The SNRM-C 106 is responsible for managing network resources on behalf of the VAL UE 102. The SNRM-C 106 facilitates interactions between the VAL UE 102 and the SNRM-S 110. Specifically, SNRM-C 106 handles requests related to multicast, and broadcast resources required for group communication services. The SNRM-C 106 ensures that session join notifications from VAL UE 102 are transmitted to SNRM-S 110 for further processing. The SNRM-C 106 communicates with the SNRM-S 110 over the SEAL-UU reference point 103. FIG. 1 illustrates the interaction between the VAL client(s) 104 and the SNRM-C 106 within a VAL UE 102 over the SEAL client (SEAL-C) reference point 105.

The VAL server 108 is responsible for hosting group communication services. The VAL server 108 manages VAL groups where users participate in activities such as information and media sharing (audio, video, text, files, etc.) during active sessions. Upon receiving session join notifications from SNRM-S 110, the VAL server 108 coordinates media exchange among users and ensures seamless group communication over multicast or broadcast channels in the 3GPP network system 112.

When the group service is hosted by the VAL server 108, the MBS session is selected for multicasting the group media over 3GPP network system 112. Hence, the VAL server 108 creates MBS resources on 3GPP network system 112 with the required quality of service (QoS) and VAL UEs (part of the group service) by consuming the services exposed by SNRM-S 110 and on successful creation of the MBS session the SNRM-S 110 performed MBS announcements (requesting group join indication) to the VAL UE 102. The interactions between the VAL server 108 and the SNRM-S 110 are over the SEAL server (SEAL-S) reference point 107.

The SNRM-S 110 processes session join notifications received from SNRM-C 106 and informs the VAL server 108 about the readiness of VAL users to send or receive media over multicast or broadcast channels. SNRM-S 110 interacts with underlying 3GPP network system 112 components to ensure efficient resource utilization for group communication services.

When receiving this notification from SNRM-S 110, the VAL server 108 determines whether VAL UE 102 is the first UE to join the MBS session. In such a scenario, the VAL server 108 starts group media multicasting over the newly created MBS session. If VAL UE 102 is the not first UE to join the MBS session and the group media was currently unicast to UE. In such a scenario, the VAL server 108 unicast is stopped and the existing MBS session is updated to multicast group media to the VAL UE 102.

For various VAL services listened by the VAL user, for example a group communication over a 5G network that performs multicast, broadcast of media with one or more group participants, the VAL services require MBS resources allocation over the 5G network. There may be multiple such services with different QoS requirements, which may have separate MBS sessions in the 5G network. When a group media decreases to less than the QoS requirement, it is important to share the listening status report to convey the quality issue to ensure better quality of experience (QoE) to the VAL user.

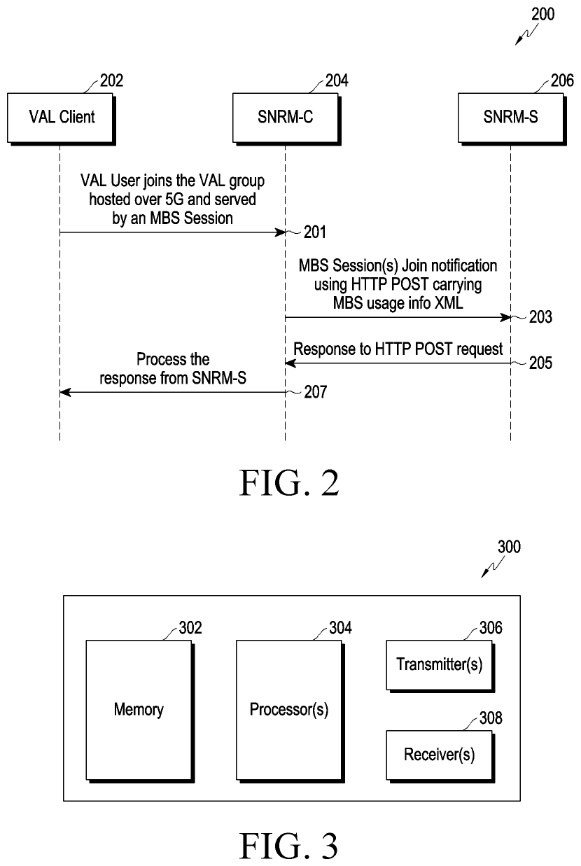

FIG. 2 illustrates a call flow for sharing a UE session join notification for a MBS session in 5G using SNRM service, according to an embodiment.

Referring to FIG. 2, the signal flow 200 comprises a VAL client 202, an SNRM-C 204, and an SNRM-S 206.

In step 201, the VAL client 202 user joins a VAL group hosted over a 5G network. The VAL group is served by an MBS session, which facilitates group communication which enables the sharing of multimedia content like audio, video, text and files among users.

In step 203, the SNRM-C 204 associated with the UE generates an HTTP POST request and transmits the HTTP POST request to the SNRM-S 206, carrying MBS session join notification information in MBS usage info XML. The HTTP POST request is used to securely send data to the server, creating or updating a resource. Step 203 is critical for notifying the SNRM-S about the SNRM-C 204 at UE participation in the MBS session. In the above example, the functionality of the said UE may be performed by using a VAL UE 102.

In step 205, upon receiving the HTTP POST request, the SNRM-S 206 parses the MBS session join notification information in MBS usage info XML received in HTTP POST request to determine the required action and data. Based on the analysis, the SNRM-S 206 responds to the HTTP POST request. The response may include status information about the HTTP POST request or provide the data requested by the SNRM-C. The response is then transmitted back to the SNRM-C at SNRM-C 204 at UE, ensuring that the necessary information is communicated effectively.

In step 207, the SNRM-C 204 at UE processes the response received from the SNRM-S 206 and transmits the result of the UE session join notification to the VAL client 202. Step 207 ensures that all relevant parties are informed about the SNRM-C 204 at UE participation in the MBS session, facilitating seamless group communication over the 5G network. The shared MBS session is utilized whenever the VAL user wants to exchange various types of content such as audio, video, text, and files.

Disclosed herein are various technical effects, such as for VAL services including group communication over 5G network that requires multicast or broadcast of group media with group participants, which may require multicast MBS resources with QoS requirements allocation over 5G. Therefore, when the UE session join notification for a particular multicast MBS session is sent from SNRM-C to SNRM-S, the UE session join notification is further shared with the VAL server. Upon receiving this notification from SNRM-S, the VAL server determines whether UE is the first UE to join the MBS session. If so, the VAL server starts group media multicasting over the newly created MBS session. If UE is the not first UE to join the MBS session and the group media was currently unicast to UE, the VAL server may stop unicast and the existing MBS session is updated to multicast group media to the UE.

FIG. 3 illustrates a SNRM-C at the UE for sharing a session join notification for a MBS session in 5G using SNRM service, according to an embodiment.

Referring to FIG. 3, the system 300 includes a memory 302, one or more processors 304, transmitter 306 and receiver 308. The one or more processors 304 are communicatively connected to the memory 302, transmitter 306 and the receiver 308. The system 300 may include more or fewer components than those depicted herein. The various components of the system 300 may be implemented using hardware, software, firmware, or any combinations thereof. The various components of the system 300 may be operably coupled with each other. More specifically, various components of the system 300 may be capable of communicating with each other using communication channel media (such as buses, interconnects, etc.).

The memory 302 is capable of storing machine executable instructions, referred to herein as instructions. The one or more processors 304 is embodied as an executor of software instructions and is capable of executing the instructions stored in the memory 302 to perform one or more operations described herein.

The memory 302 can be any type of storage accessible to the one or more processors 304 to perform respective functionalities. For example, the memory 302 may include one or more volatile or non-volatile memories, or a combination thereof. For example, the memory 302 may be embodied as semiconductor memories, such as flash memory, mask read only memory (ROM), programmable ROM (PROM), erasable PROM (EPROM), random access memory (RAM), and the like.

The one or more processors 304 are configured to generate a HTTP POST request based on a request from a VAL client of the UE. The HTTP POST request includes a uniform resources identifier (URI), a content type header and an MBS usage info XML document as a message payload. The request-URI may correspond to an identity of the SNRM-S.

To generate the HTTP POST request the one or more processors 304 may be configured to receive, the request to share the UE MBS session join notification with the SNRM-S from the VAL client.

The one or more processors 304 may be configured to transmit the UE session join notification for MBS session using the HTTP POST request towards an SNRM-S. The UE session join notification includes an MBS Usage Info XML document encoded using an MBS Usage Info XML schema with mbs-session-join-notification XML field and associated XML child elements. The mbs-session-join-notification XML field may be coded as per mbs-session-join-notificationType XML complex element.

The XML fields include at least one field of:
ComplexType name as a “mbs-session-join-notificationType”,
an element name as “VAL-identities type” set as “sealinfo: sealinfo-Type”,
an element name as “mbs-session-id” set as “xs: string”,
an element name as “mbs-multicast-joining-status” set as “xs: string”,
an element name as “mbs-reception-quality-level” set as “xs: integer”,
any name space as “##other” process contents as “lax” and minOccurs=“0”, and
any attribute name space as “##any” processContents=“lax”.

The mbs-session-join-notificationType XML complex element includes:
a VAL identities sub-element, wherein the VAL-identities sub-element comprises at least one of a VAL-user-id element and a VAL-group-id;
an MBS session id sub-element, wherein the MBS session id sub element indicating the MBS session identifier associated with the group for which a group join notification is shared;
an MBS multicast joining sub-element, wherein the MBS multicast joining sub-element is set to the string “successfully joined”; and
an MBS reception quality level, wherein the MBS reception quality level is an optional element containing an integer used to indicate the reception quality level of the media.

The one or more processors 304 may be configured to receive a response from the SNRM-S. The response is at least based on parsing of the MBS Usage Info XML. The one or more processors 304 may further be configured to update at least one of the VAL client, or the UE MBS session join notification based on a response from the SNRM-S.

The one or more processors 304 may be configured to parse a UE session join notification for an MBS session in a SNRM service. To parse, the one or more processors 304 may be configured to receive the UE session join notification for the MBS session within an HTTP POST request by the SNRM-C, from the UE. The SNRM-S may be configured to receive a content-type header filed with “application/vnd.3gpp.seal-mbs-usage-info+xml” value.

The one or more processors 304 may be configured to determine an identity of the sender of the received UE session join notification and to generate a response based on validation of the identity of the sender. The response is a positive response comprising parsed MBS Usage Info XML if the identity of the sender is authorized.

The one or more processors 304 may be configured to store the response based on the processed HTTP POST request for future usage to serve requests from the SNRM-C associated with the HTTP POST request.

The one or more processors 304 may be configured to process the HTTP POST request body carrying the UE MBS session join status notification status. The VAL identities, MBS session identity, MBS multicast joining status and the MBS reception quality level shared by the SNRM-C are processed by the SNRM-S if the identity of the sender of the received HTTP POST request is authorized.

The response is a negative response if the identity of the sender is not authorized. In this case, the one or more processors 304 are configured to omit parsing of the MBS usage info XML. The response transmitted is an HTTP 403 (Forbidden) response to the HTTP POST request, and the one or more processors 304 may be configured to skip the remaining steps if the identity of the sender of the received HTTP POST request is not authorized. The one or more processors 304 may be configured to transmit the generated response to the UE.

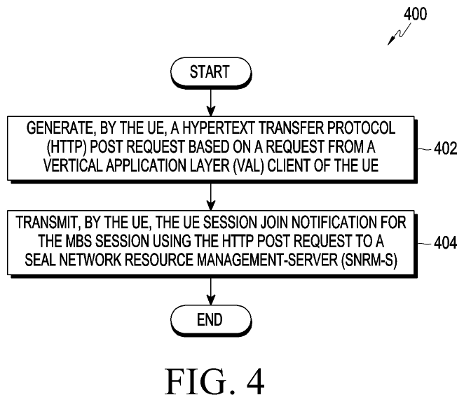

FIG. 4 illustrates a method for sharing a UE session join notification for a MBS session in 5G using SNRM service, according to an embodiment. Referring to FIG. 4, the method 400 may be performed at a UE.

In step 402, the method 400 includes generating, by the UE, a HTTP POST request based on a request from a VAL client of the UE. The HTTP POST request includes a uniform resources identifier (URI), a content type header and an MBS usage info XML document as a message payload. In an embodiment of the present disclosure, the request-URI may correspond to an identity of the SNRM-S.

The step of generating the HTTP POST request may further includes receiving, by the UE, the request to share the UE MBS session join notification with the SNRM-S from the VAL client.

In step 404, the method 400 includes transmitting, by the UE, the UE session join notification for the MBS session using the HTTP POST request to an SNRM-S. The UE session join notification includes an MBS usage info XML document encoded using an MBS Usage Info XML schema with mbs-session-join-notification XML field and associated XML child elements. The mbs-session-join-notification XML field may be coded as per mbs-session-join-notificationType XML complex element.

The XML fields include at least one field of:
ComplexType name as a “mbs-session-join-notification Type”,
an element name as “VAL-identities type” set as “sealinfo: sealinfo-Type”,
an element name as “mbs-session-id” set as “xs: string”,
an element name as “mbs-multicast-joining-status” set as “xs: string”,
an element name as “mbs-reception-quality-level” set as “xs: integer”,
any name space as “##other” process contents as “lax” and minOccurs=“0”, and
any attribute name space as “##any” processContents=“lax”.

The mbs-session-join-notificationType XML complex element includes:
a VAL identities sub-element, wherein the VAL-identities sub-element comprises at least one of a VAL-user-id element and a VAL-group-id;
an MBS session id sub-element, wherein the MBS session id sub element indicating the MBS session identifier associated with the group for which a group join notification is shared;
an MBS multicast joining sub-element, wherein the MBS multicast joining sub-element is set to the string “successfully joined”; and
an MBS reception quality level, wherein the MBS reception quality level is an optional element containing an integer used to indicate the reception quality level of the media.

The method 400 may further include receiving, by the UE, a response from the SNRM-S. The response is at least based on parsing of the MBS usage info XML. The method 400 may further include updating, by the UE to the VAL client, the UE MBS session join notification based on a response from the SNRM-S.

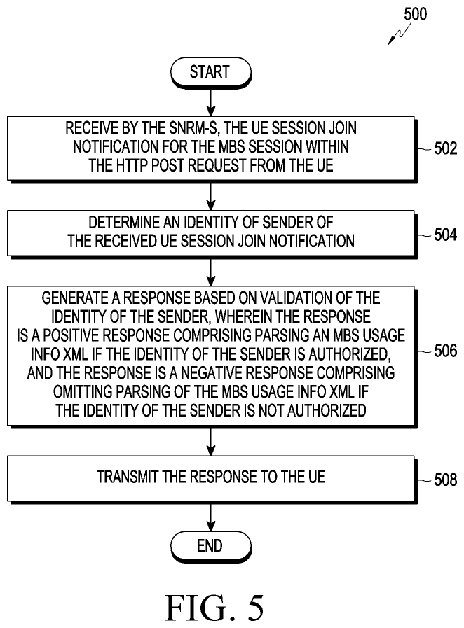

FIG. 5 illustrates a method for parsing a UE session join notification for a MBS session in 5G using SNRM service, according to an embodiment. Referring to FIG. 5, the method 500 may be performed by a SNRM-Server (SNRM-S).

The method 500 includes parsing a UE session join notification for an MBS session in a SNRM service. In step 502, the method 500 includes receiving the UE session join notification for the MBS session within the HTTP POST request from the UE. The SNRM-S includes receiving a content-type header filed with “application/vnd.3gpp.seal-mbs-usage-info+xml” value.

In step 504, the method 500 includes determining an identity of a sender of the received UE session join notification. In step 506, the method 500 includes generating a response based on validation of the identity of the sender. If the identity of the sender is authorized the response is a positive response comprising parsing the MBS usage info XML.

In step 506, the method 500 includes processing the HTTP POST request body carrying the UE MBS session join status notification status. The VAL identities, MBS session identity, the MBS joining status and the MBS reception quality level shared by the SNRM-C are processed by the SNRM-S if the identity of the sender of the received HTTP POST request is authorized. The method 500 may then comprise preparing and storing the response based on the processed HTTP POST request for future usage to serve requests from the SNRM-C associated with the HTTP POST request.

If the identity of the sender is not authorized, the response is a negative response comprising omitting parsing of the MBS usage info XML. The response transmitted is an HTTP 403 (Forbidden) response to the HTTP POST request and the remainder of the steps is skipped if the identity of the sender of the received HTTP POST request is not authorized. In step 508, the method 500 includes transmitting the response to the UE.

Disclosed herein are various technical effects, such as for VAL services including group communication over a 5G network that requires multicast of group media with group participants. These services may require multicast MBS resources with QoS requirements allocation over 5G. Therefore, when the proposed UE session join notification for a particular multicast MBS session is sent from SNRM-C to SNMR-S, the UE session join notification is further shared with VAL server. Upon receiving this notification from SNRM-S, the VAL server determines whether UE is the first UE to join the MBS session. If so, the VAL server starts group media multicasting over the newly created MBS session. If UE is the not first UE to join the MBS session and the group media was currently unicast to UE, the VAL server unicast is stopped and the existing MBS session is updated to multicast group media to the UE.

It will be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, regardless of whether such computer or processor is illustrated.

The sequence of operations of the methods disclosed herein need not be necessarily executed in the same order as they are presented. One or more operations may be grouped together and performed in the form of a single step, or one operation may have several sub-steps that may be performed in parallel or in sequential manner.

The methods disclosed herein may be implemented using software including computer-executable instructions stored on one or more computer-readable media (e.g., non-transitory computer-readable media, such as one or more optical media discs, volatile memory components or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

One or more computer-readable storage media may be utilized in implementing embodiments of the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” may be understood to include tangible items and exclude carrier waves and transient signals, i.e., be non-transitory. Examples include random access memory (RAM), read-only memory (ROM), volatile memory, non-volatile memory, hard drives, compact disc (CD) ROMs, DVDs, flash drives, disks, and any other known physical storage media.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method by a service enabler architecture layer network resource management (SNRM) client (SNRM-C) in a user equipment (UE), the method comprising:
generating a hypertext transfer protocol (HTTP) POST request to share UE group join notification status with a SNRM server (SNRM-S) based on a request from a vertical application layer (VAL) client in the UE, wherein the HTTP POST request includes UE session join notification for a multicast and broadcast services (MBS) session; and
transmitting, to the SNRM-S, the HTTP POST request including the UE session join notification for the MBS session.

2. The method as claimed in claim 1, wherein the HTTP POST request comprises a request uniform resources identifier (URI), a content type header, and an MBS usage info extensible markup language (XML) payload.

3. The method as claimed in claim 2, wherein the MBS usage info XML payload comprises the UE session join notification for the MBS session to share the group joining notification.

4. The method as claimed in claim 3, wherein the UE session join notification for the MBS session comprises at least one of:
a VAL identities sub-element, wherein the VAL-identities sub-element comprises at least one of a VAL-user-id element and a VAL-group-id;
an MBS session id sub-element, wherein the MBS session id sub element indicating the MBS session identifier associated with the group for which a group join notification is shared;
an MBS multicast joining sub-element, wherein the MBS multicast joining sub-element is set to the string “successfully joined”; and
an MBS reception quality level, wherein the MBS reception quality level is an integer used to indicate the reception quality level of the media.

5. The method as claimed in claim 1, further comprising:
receiving a response from the SNRM-S, wherein the response is at least based on parsing of an MBS Usage Info XML.

6. The method as claimed in claim 1, wherein generating the HTTP POST request further comprising:
receiving, from the VAL client, the request to share the UE MBS session join notification with the SNRM-S.

7. The method as claimed in claim 1, further comprising:
updating the UE MBS session join notification based on a response from the SNRM-S.

8. The method as claimed in claim 2, further comprising:
setting the request-URI to a URI corresponding to an identity of the SNRM-S.

9. The method as claimed in claim 1, further comprising:
receiving by the SNRM-S, the UE session join notification for the MBS session within the HTTP POST request from the UE;
determining an identity of sender of the received UE session join notification;
generating a response based on validation of the identity of the sender,
wherein the response is a positive response comprising parsing an MBS Usage Info XML if the identity of the sender is authorized, and
wherein the response is a negative response comprising omitting parsing of the MBS Usage Info XML if the identity of the sender is not authorized; and
transmitting the response to the UE.

10. A method by a service enabler architecture layer network resource management (SNRM) server (SNRM-S), the method comprising:
receiving, from a SNRM client (SNRM-C) in a user equipment (UE), a hypertext transfer protocol (HTTP) POST request to share UE group join notification status with the SNRM-C) based on a request from a vertical application layer (VAL) client in the UE, wherein the HTTP POST request includes UE session join notification for a multicast and broadcast services (MBS) session; and
transmitting, to the SNRM-C, a response in response to the HTTP POST request including the UE session join notification for the MBS session.

11. The method as claimed in claim 10, wherein the HTTP POST request comprises a request uniform resources identifier (URI), a content type header, and an MBS usage info extensible markup language (XML) payload.

12. The method as claimed in claim 10, wherein the MBS usage info XML payload comprises the UE session join notification for the MBS session to share the group joining notification.

13. The method as claimed in claim 12, wherein the UE session join notification for the MBS session comprises at least one of:
a VAL identities sub-element, wherein the VAL-identities sub-element comprises at least one of a VAL-user-id element and a VAL-group-id;
an MBS session id sub-element, wherein the MBS session id sub element indicating the MBS session identifier associated with the group for which a group join notification is shared;
an MBS multicast joining sub-element, wherein the MBS multicast joining sub-element is set to the string “successfully joined”; and
an MBS reception quality level, wherein the MBS reception quality level is an integer used to indicate the reception quality level of the media.

14. A user equipment (UE) including a service enabler architecture layer network resource management (SNRM) client (SNRM-C), the UE comprising:
at least one transceiver;
at least one processor communicatively coupled to the at least one transceiver; and
at least one memory, communicatively coupled to the at least one processor, storing instructions executable by the at least one processor individually or in any combination to cause the UE to:
generate a hypertext transfer protocol (HTTP) POST request to share UE group join notification status with a SNRM server (SNRM-S) based on a request from a vertical application layer (VAL) client in the UE, wherein the HTTP POST request includes UE session join notification for a multicast and broadcast services (MBS) session, and
transmit, to the SNRM-S, the HTTP POST request including the UE session join notification for the MBS session.

15. The UE as claimed in claim 14, wherein the HTTP POST request comprises a request uniform resources identifier (URI), a content type header, and an MBS usage info extensible markup language (XML) payload.

16. The UE as claimed in claim 15, wherein the MBS usage info XML payload comprises the UE session join notification for the MBS session to share the group joining notification.

17. The UE as claimed in claim 16, wherein the UE session join notification for the MBS session comprises at least one of:
a VAL identities sub-element, wherein the VAL-identities sub-element comprises at least one of a VAL-user-id element and a VAL-group-id;
an MBS session id sub-element, wherein the MBS session id sub element indicating the MBS session identifier associated with the group for which a group join notification is shared;
an MBS multicast joining sub-element, wherein the MBS multicast joining sub-element is set to the string “successfully joined”; and
an MBS reception quality level, wherein the MBS reception quality level is an integer used to indicate the reception quality level of the media.

18. A service enabler architecture layer network resource management (SNRM) server (SNRM-S), the SNRM-S comprising:
at least one transceiver;
at least one processor communicatively coupled to the at least one transceiver; and
at least one memory, communicatively coupled to the at least one processor, storing instructions executable by the at least one processor individually or in any combination to cause the SNRM-S to:
receive, from a SNRM client (SNRM-C) in a user equipment (UE), a hypertext transfer protocol (HTTP) POST request to share UE group join notification status with the SNRM-C) based on a request from a vertical application layer (VAL) client in the UE, wherein the HTTP POST request includes UE session join notification for a multicast and broadcast services (MBS) session, and
transmit, to the SNRM-C, a response in response to the HTTP POST request including the UE session join notification for the MBS session.

19. The SNRM-S as claimed in claim 18, wherein the HTTP POST request comprises a request uniform resources identifier (URI), a content type header, and an MBS usage info extensible markup language (XML) payload.

20. The SNRM-S as claimed in claim 19, wherein the MBS usage info XML payload comprises the UE session join notification for the MBS session to share the group joining notification.
